(19) United States
(12) Patent Application Publication
(10) Pub. No.: US 2022/0207217 A1
(43) Pub. Date: Jun. 30, 2022

(54) METHOD AND SYSTEM FOR REAL-TIME SIMULATION USING DIGITAL TWIN AGENT

(71) Applicant: Electronics and Telecommunications Reserch Institute, Daejeon (KR)

(72) Inventors: Hark Jin LEE, Daejeon (KR); Min Gi KIM, Daejeon (KR); Eun Seo LEE, Daejeon (KR); Ji Yeon SON, Daejeon (KR)

(73) Assignee: Electronics and Telecommunications Research Institute, Daejeon (KR)

(21) Appl. No.: 17/525,086

(22) Filed: Nov. 12, 2021

(30) Foreign Application Priority Data
Dec. 31, 2020 (KR) 10-2020-0189492

(51) Int. Cl. G06F 30/27; G06N 20/00

(52) U.S. Cl. CPC G06F 30/27; G06F 2119/18; G06N 20/00

(57) ABSTRACT

A simulation method and system for real-time simulation using digital twin agent are disclosed. The simulation method may include generating a digital twin object cyberizing a manufacturing resource required for a process based on manufacturing resource information, mapping a learning model onto the digital twin object and transmitting the learning model mapped onto the digital twin object to a digital twin agent, receiving information analyzed by using the learning model from the digital twin object of the digital twin agent, and performing a simulation based on the received information.

### CROSS-REFERENCE TO RELATED APPLICATION

This application claims the benefit of Korean Patent Application No. 10-2020-0189492 filed on Dec. 31, 2020, in the Korean Intellectual Property Office, the entire disclosure of which is incorporated herein by reference for all purposes.

### BACKGROUND

### 1. Field of the Invention

One or more example embodiments relate to a real-time simulation method and system, more particularly, a method and system for real-time simulation related to a smart factory using digital twin agent.

### 2. Description of the Related Art

A smart-factory related simulation method is a method of determining an optimal processing line and optimal equipment for a factory by designing the processing line and allocating the equipment by performing a simulation.

However, a defect rate or working hours may vary according to a condition even in a same processing line of a manufacturing system. For example, a processing line for a vehicle door trim assembly may include diverse processes such as an input process, an assembly process, an assembly process 2, and a completion inspection process. Here, working hours may vary according to workers in the process. In addition, when humidity increases due to weather such as rain or snow, a defect rate may increase due to the humid environment and working hours may increase in summer due to heat. That is, since a processing time and a defect rate may vary due to various causes, an actual processing time may differ from an average working hour according to circumstances.

However, a conventional simulation system does not consider above mentioned factors and designs a processing line by performing a simulation based on past information. Thus, a process should be optimized by tuning the process according to a condition occurring during production in an actual processing line.

Thus, there is a demand for a method of performing a simulation that reflects real-time manufacturing resource information.

### SUMMARY

Example embodiments provide a system and a method of processing information accurately by a process simulation in real-time by performing a simulation based on a result obtained by analyzing real-time manufacturing resource information by a digital twin agent using a learning model.

In addition, example embodiments provide the system and the method of providing a simulation service immediately reflecting a change in a processing line for small quantity batch production by transmitting a digital twin object to the digital twin agent, storing a result obtained by analyzing real-time manufacturing resource information by the digital twin agent using the learning model in the digital twin object, and performing a simulation by receiving the information stored in the digital twin object.

In addition, example embodiments provide the system and the method of rapidly identifying a cause of a problem required for optimizing a process or equipment by comparing each piece of information analyzed by the digital twin agents receiving same learning model or manufacturing resource information.

According to an aspect, there is provided a simulation method including generating a digital twin object cyberizing a manufacturing resource required for a process based on manufacturing resource information, mapping a learning model onto the digital twin object and transmitting the learning model mapped onto the digital twin object to a digital twin agent, receiving information analyzed by using the learning model from the digital twin object of the digital twin agent, and performing a simulation based on the received information.

The digital twin agent may collect the manufacturing resource information in real time, learn the collected manufacturing resource information using the learning model, and store information analyzed by learning in the digital twin object.

The generating of the digital twin object may include generating a simulation model based on the manufacturing resource information collected from the manufacturing resource and generating the digital twin object based on the simulation model.

The digital twin agent may learn a process optimized to current manufacturing resource information by applying the manufacturing resource information collected in real time to a process learning model and store manufacturing resource information required for performing the optimized process in the digital twin object.

The performing of the simulation may include performing the simulation by setting a process of a simulation model according to information stored in the digital twin object of the digital twin agent.

The digital twin agent may learn equipment optimized to current manufacturing resource information by applying the manufacturing resource information collected in real-time to an equipment learning model and store the manufacturing resource information required for setting the optimized equipment in the digital twin object.

The performing of the simulation may include performing the simulation by setting equipment of the simulation model based on the information stored in the digital twin object of the digital twin agent.

According to an aspect, there is provided a simulation system including a digital twin configurator configured to map a learning model onto a digital twin object cyberizing a manufacturing resource required for a process based on manufacturing resource information and transmit the learning model mapped onto the digital twin object to a digital twin agent and a simulator configured to receive information analyzed by using the learning model from the digital twin object of the digital twin agent and perform a simulation based on the received information.

The digital twin agent may collect the manufacturing resource information in real-time, learns the collected manufacturing resource information using the learning model, and store information analyzed by learning in the digital twin object.

The digital twin agent may learn a process optimized to current manufacturing resource information by applying the manufacturing resource information collected in real-time to a process learning model and store manufacturing resource information required for performing the optimized process in the digital twin object.

The simulator may perform the simulation by setting a process of a simulation model according to information stored in the digital twin object of the digital twin agent.

The digital twin agent may learn equipment optimized to current manufacturing resource information by applying the manufacturing resource information collected in real-time to an equipment learning model and store the manufacturing resource information required for setting the optimized equipment in the digital twin object.

The simulator may perform the simulation by setting equipment of the simulation model based on the information stored in the digital twin object of the digital twin agent.

Additional aspects of example embodiments will be set forth in part in the description which follows and, in part, will be apparent from the description, or may be learned by practice of the disclosure.

According to example embodiments, an agent-based smart factory may be constructed to process a process simulation of accurate information in real-time by performing a simulation based on a result obtained by analyzing real-time manufacturing resource information using a learning model by a digital twin agent.

In addition, according to example embodiments, a simulation service immediately reflecting a change in the processing line for small quantity batch production by transmitting the digital twin object to the digital twin agent, storing a result obtained by analyzing real-time manufacturing resource information by the digital twin agent using the learning model in the digital twin object, and performing the simulation by receiving the information stored in the digital twin object may be provided.

In addition, according to example embodiments, a cause of a problem required for optimizing a process or equipment by comparing each piece of information analyzed by the digital twin agents receiving same learning model or manufacturing resource information may be rapidly identified.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a simulation system according to an example embodiment;

FIG. 2 is a detailed diagram illustrating a simulation system according to an example embodiment;

FIG. 3 is a diagram illustrating a relationship between a digital twin agent and other components of a simulation system according to an example embodiment;

FIG. 4 is a flowchart illustrating a simulation method according to an example embodiment; and

FIG. 5 is a diagram illustrating an operation of components of a simulation system based on a simulation method according to an example embodiment.

### DETAILED DESCRIPTION

Hereinafter, example embodiments will be described in detail with reference to the accompanying drawings. However, various alterations and modifications may be made to the example embodiments. Here, the example embodiments are not construed as limited to the disclosure. The example embodiments should be understood to include all changes, equivalents, and replacements within the idea and the technical scope of the disclosure.

The terminology used herein is for the purpose of describing particular example embodiments only and is not to be limiting of the example embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

When describing the example embodiments with reference to the accompanying drawings, like reference numerals refer to like constituent elements and a repeated description related thereto will be omitted. In the description of example embodiments, detailed description of well-known related structures or functions will be omitted when it is deemed that such description will cause ambiguous interpretation of the present disclosure.

Hereinafter, example embodiments will be described in detail with reference to the accompanying drawings.

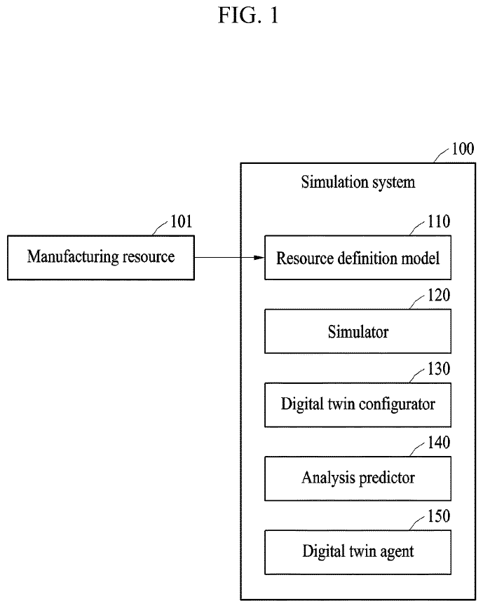

FIG. 1 is a diagram illustrating a simulation system according to an example embodiment.

A simulation system 100 may include a resource definition model 110, a simulator 120, a digital twin configurator 130, an analysis predictor 140, and a digital twin agent 150 as shown in FIG. 1. Here, the resource definition model 110, the simulator 120, the digital twin configurator 130, the analysis predictor 140, and the digital twin agent 150 may be different processors, or separate modules included in a program executed by a single processor.

The resource definition model 110 may collect manufacturing resource information from a manufacturing resource 101. In addition, the resource definition model 110 may organize, store, and manage analysis information analyzed by the digital twin agent 150 and information on a processing line and equipment determined by a simulation performed by the simulator 120 based on the analysis information.

The simulator 120 may generate a digital twin object cyberizing a manufacturing resource required for a process based on manufacturing resource information collected by the resource definition model 110 from the manufacturing resource 101. More specifically, the simulator 120 may generate a simulation model based on manufacturing resource information. In addition, the simulator 120 may generate the digital twin object based on the simulation model. Here, the simulator 120 may perform a simulation using the generated simulation model and may generate the digital twin object by modifying the simulation model based on an analysis result from the analysis predictor 140.

In addition, the simulator 120 may generate the digital twin object by utilizing a tool which may reflect know-how of a worker to the digital twin object.

More specifically, the simulator 120 may provide a simulator user interface (UI) to a user. In addition, the simulator 120 may generate or correct the simulation model based on information input through the simulator UI.

For example, a simulation model reflecting a present equipment specification in a process may set that five products may be manufactured. However, a user may have the know-how obtained from experience to manufacture up to six products if a temperature is 25 degrees or more. Here, the simulator 120 may correct an environment of the simulation model to 25 degrees or more based on information input through the simulator UI and may correct the setting such that six products may be manufactured in the equipment.

In addition, when five molds are included in the equipment, a user may have know-how from experience that if the second mold is broken, the third mold is also broken. Here, the simulator 120 may correct the setting to replace both the second mold and the third mold when the second mold is broken in the simulation model based on the information input through the simulator UI.

In addition, the simulator 120 may receive information analyzed by using a learning model from the digital twin object of the digital twin agent 150. In addition, the simulator 120 may perform a simulation based on the received information.

The digital twin configurator 130 may map a learning model generated in the analysis predictor 140 onto the digital twin object generated in the simulator 120 and may transmit the learning model mapped onto the digital twin object to the digital twin agent 150.

The analysis predictor 140 may generate the learning model by performing an artificial intelligence (AI)-based analysis and prediction on learning information. Here, the learning model may include at least one of a process learning model to learn an optimized process and an equipment learning model to learn optimized equipment. In addition, the process learning model may be a learning model to automatically perform a process time reduction by know-how of a user or process information collected in real time. In addition, the equipment learning model may be a learning model to learn a case in which equipment operation time varies according to a temperature. Thus, based on a result of the equipment learning model, the equipment operation time may be modified corresponding to the temperature and may be reflected in the simulation model.

In addition, the learning information may be information matching analysis information stored in the resource definition model 110 and information on the processing line and equipment determined based on the analysis information.

The digital twin agent 150 may collect manufacturing resource information in real-time, learn the collected manufacturing resource information using the learning model, and store information analyzed by learning in the digital twin object.

The simulation system 100 may include a plurality of digital twin agents 150 and may rapidly identify a cause of a problem that is a reason for optimizing a process or equipment by comparing each piece of information analyzed by the digital twin agents 150 receiving same learning model or manufacturing resource information.

In addition, the digital twin agent 150 may receive any one of the process learning model and the equipment learning model by the digital twin configurator 130.

The digital twin agent 150 receiving the process learning model may learn a process optimized to current manufacturing resource information by applying manufacturing resource information collected in real-time from the manufacturing resource 101 to the process learning model. In addition, the digital twin agent 150 receiving the process learning model may store the manufacturing resource information required for performing the optimized process in the digital twin object received from the digital twin configurator 130. Here, the simulator 120 may perform a simulation by setting a process of a simulation model based on the information stored in the digital twin object of the digital twin agent 150 receiving the process learning model.

In addition, the digital twin agent 150 receiving the equipment learning model may learn equipment optimized to current manufacturing resource information by applying manufacturing resource information collected in real-time from the manufacturing resource 101 to the equipment learning model. In addition, the digital twin agent 150 receiving the equipment learning model may store the manufacturing resource information required for setting the optimized equipment from the digital twin configurator 130 in the digital twin object. Here, the simulator 120 may perform a simulation by setting equipment of a simulation model based on the information stored in the digital twin object of the digital twin agent 150 receiving the equipment learning model.

The simulation system 100 may construct an agent-based smart factory to process a process simulation in real-time based on accurate information by performing a simulation based on a result obtained by analyzing real-time manufacturing resource information using the learning model by the digital twin agent 150. For example, when working days increase, a worker may reduce working hours by using working know-how. Thus, the simulation system 100 may perform a simulation considering the reduced working hours reduced by the working know-how of the worker. In addition, the simulation system 100 may perform a simulation wherein respective working hours of workers may increase in summer considering that working hours increase due to heat.

In addition, the simulation system 100 may provide a simulation service immediately reflecting a change in a processing line for small quantity batch production by transmitting the digital twin object to the digital twin agent, storing a result obtained by the digital twin agent analyzing real-time manufacturing resource information using the learning model, in the digital twin object, and performing a simulation by receiving the information stored in the digital twin object.

In addition, the simulation system 100 may identify a cause of a problem that is a reason for optimizing a process or equipment by comparing each piece of information analyzed by the digital twin agents 150 receiving the same learning model or manufacturing resource information.

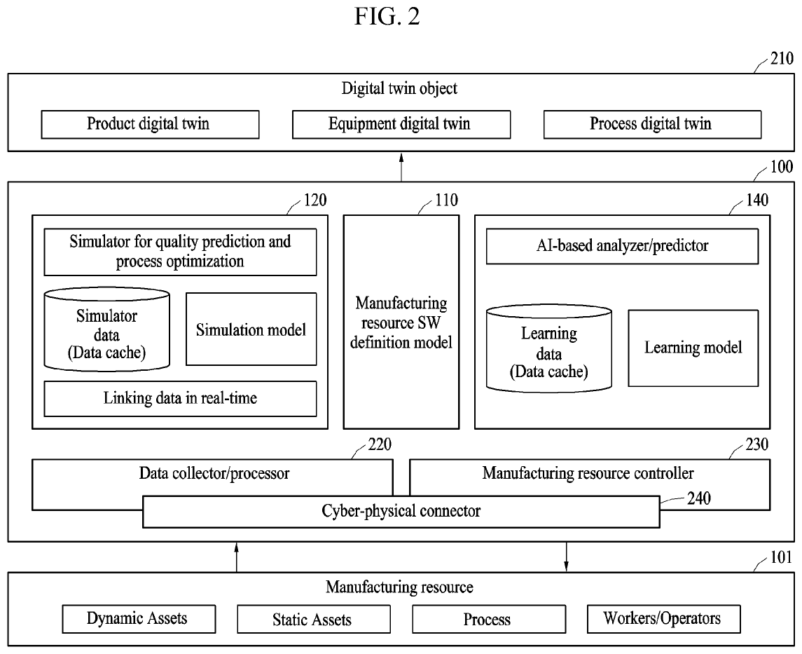

FIG. 2 is a detailed diagram illustrating a simulation system according to an example embodiment.

The resource definition model 110 may store manufacturing resource information received from the manufacturing resource 101 through a cyber-physical connector 240. For example, the resource definition model 110 may be a manufacturing resource software (SW) definition model database.

The cyber-physical connector 240 may include a manufacturing resource controller 230 to control the manufacturing resource 101 and a data collector/processor 220 to collect and process manufacturing resource information from the manufacturing resource 101.

The simulator 120 may generate a simulation model based on manufacturing resource information and may perform a simulation by linking manufacturing resource information received in real-time from the manufacturing resource 101 through the cyber-physical connector 240 with the simulation model. However, when the manufacturing resource information received in real-time exceeds a process performance maximum of the simulator 120, a process of linking with the simulation model may be delayed, or the manufacturing resource information may not be processed. Accordingly, the simulator 120 may generate a digital twin object 210 based on the simulation model and may transmit the generated digital twin object 210 to the digital twin configurator 130.

The analysis predictor 140 may generate a learning model by performing an AI-based analysis or prediction on learning data.

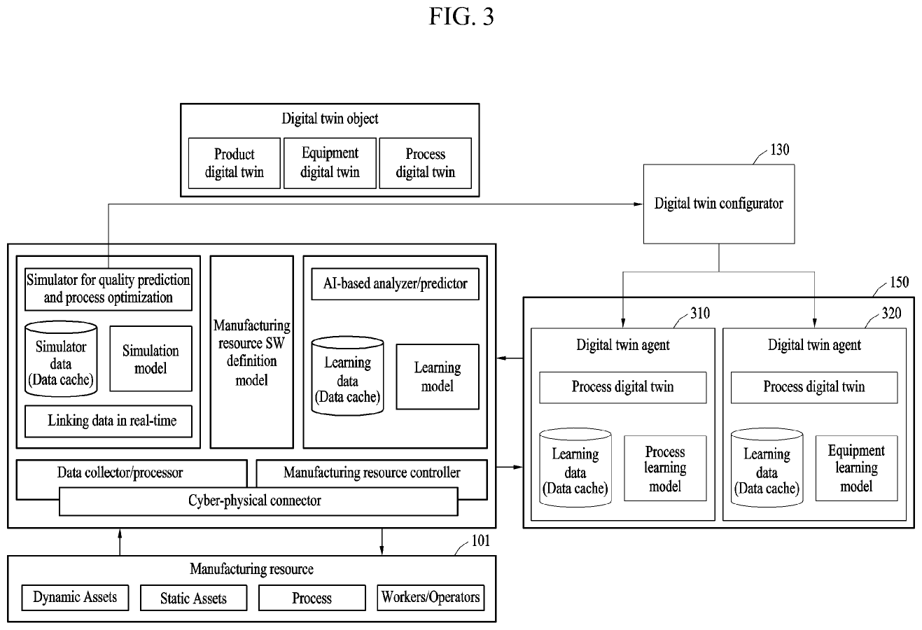

FIG. 3 is a diagram illustrating a relationship between a digital twin agent and other components of a simulation system according to an example embodiment.

The digital twin configurator 130 may map a learning model generated by the analysis predictor 140 onto a digital twin object generated in the simulator 120 and may transmit the learning model mapped onto the digital twin object to the digital twin agent 150.

Here, the digital twin agent 150 may collect manufacturing resource information in real-time from the manufacturing resource 101 through the cyber-physical connector 240. In addition, the digital twin agent 150 may periodically learn the collected manufacturing resource information using the learning model, and may store information analyzed by learning in the digital twin object.

In addition, the digital twin agent 150 may be any one of a digital twin agent 310 receiving a process learning model and a digital twin agent 320 receiving an equipment learning model.

The digital twin agent 310 may learn a process optimized to current manufacturing resource information by applying manufacturing resource information collected in real-time from the manufacturing resource 101 to the process learning model. In addition, the digital twin agent 310 may store the manufacturing resource information required for performing the optimized process in the digital twin object that is received from the digital twin configurator 130. Here, the simulator 120 may perform a simulation by setting a process of a simulation model based on information stored in the digital twin object of the digital twin agent 310.

In addition, the digital twin agent 320 may learn equipment optimized to current manufacturing resource information by applying manufacturing resource information collected in real-time from the manufacturing resource 101 to the equipment learning model. In addition, the digital twin agent 320 may store the manufacturing resource information required for setting the optimized equipment from the digital twin configurator 130 in the digital twin object. Here, the simulator 120 may perform a simulation by setting equipment of a simulation model based on information stored in the digital twin object of the digital twin agent 320.

For example, one chemical substance may be prepared through diverse processes such as a coprecipitation process, a rinsing/dehydration process, and a drying process. Here, processes being performed often need to have a real-time correlation to each other due to various conditions such as rinsing/dehydration taking more time due to the temperature increasing by one degree for an unknown reason during a chemical reaction in a coprecipitation process.

Accordingly, the simulation system 100 may collect and analyze the manufacturing resource information in real-time through the digital twin agent 150. In addition, the resource definition model 110 may organize, store, and manage analysis information including information on whether a defect occurs under a predetermined condition.

In addition, the analysis predictor 140 may process a control in real-time to extend a process time of a next process to remove a defect in a current state by transmitting a learning model generated by using information stored in the resource definition model 110 to the digital twin agent.

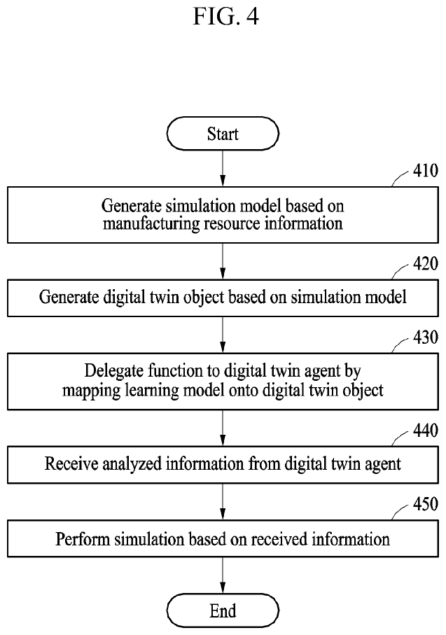

FIG. 4 is a flowchart illustrating a simulation method according to an example embodiment.

In operation 410, the simulator 120 may generate a simulation model based on manufacturing resource information collected from the manufacturing resource 101 by the resource definition model 110.

In operation 420, the simulator 120 may generate a digital twin object cyberizing a manufacturing resource required for a process based on the simulation model generated in operation 410.

In operation 430, the digital twin configurator 130 may map a learning model generated by the analysis predictor 140 onto the digital twin object generated in operation 420 and may transmit the learning model mapped onto the digital twin object to the digital twin agent 150. Here, the digital twin agent 150 may collect manufacturing resource information in real-time, learn the collected manufacturing resource information using the learning model, and store information analyzed by learning in the digital twin object.

In operation 440, the simulator 120 may receive information analyzed by using the learning model from the digital twin object of the digital twin agent 150.

In operation 450, the simulator 120 may perform a simulation based on the information received in operation 440.

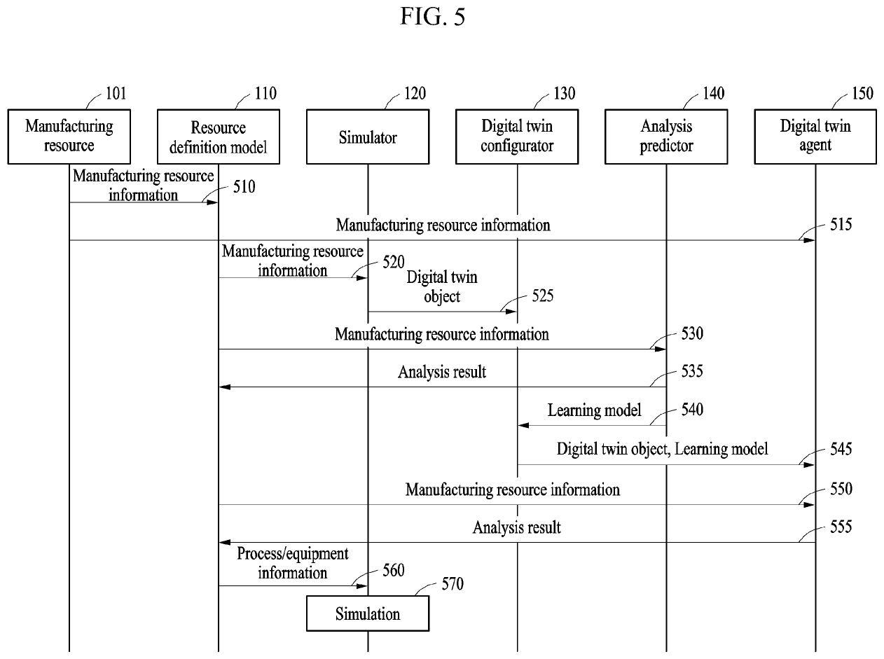

FIG. 5 is a diagram illustrating an operation of components of a simulation system based on a simulation method according to an example embodiment.

In operation 510, the cyber-physical connector 240 may transmit manufacturing resource information to the manufacturing resource definition model 110 by collecting the manufacturing resource information from the manufacturing resource 101. In addition, in operation 515, the manufacturing resource 101 may transmit the manufacturing resource information to the digital twin agent 150.

In operation 520, the manufacturing resource definition model 110 may transmit the manufacturing resource information received in operation 510 to the simulator 120. In operation 525, the simulator 120 may generate a digital twin object cyberizing a manufacturing resource required for a process based on the manufacturing resource information collected by the resource definition model 110 from the manufacturing resource 101. In addition, the simulator 120 may transmit the generated digital twin object to the digital twin configurator 130.

In operation 530, the resource definition model 110 may transmit the manufacturing resource information received in operation 510 to the analysis predictor 140. In operation 535, the analysis predictor 140 may generate an analysis result obtained by performing an AI-based analysis and prediction on learning information and the manufacturing resource information received in operation 530. In addition, the analysis predictor 140 may transmit the analysis result to the resource definition model 110 and store the analysis result in the resource definition model 110.

In operation 540, the analysis predictor 140 may generate a learning model based on the AI-based analysis and prediction performed in operation 535. In addition, the analysis predictor 140 may transmit the generated learning model to the digital twin configurator 130. In operation 540, the digital twin configurator 130 may map the learning model received in operation 540 onto the digital twin object received in operation 525 and transmit the learning model mapped onto the digital twin object to the digital twin agent 150.

In operation 550, the cyber-physical connector 240 may collect the manufacturing resource information in real-time from the manufacturing resource 101 and may transmit the manufacturing resource information to the digital twin agent 150. Here, in operation 555, the digital twin agent 150 may learn the manufacturing resource information received in operation 550 using the learning model and may store an analysis result analyzed by the learning in the digital twin object. In addition, the analysis result stored in the digital twin object may be transmitted to the resource definition model 110.

In operation 560, the resource definition model 110 may transmit information on a process or equipment included in the analysis result received in operation 555 to the simulator 120.

In operation 570, the simulator 120 may perform a simulation based on the information received in operation 560.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The simulation system or the simulation method according to example embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific example embodiments, the details should not be construed as limiting any invention or a scope that can be claimed, but rather should be construed as being descriptions of features that may be peculiar to specific example embodiments of specific inventions. Specific features described in the present specification in the context of individual example embodiments may be combined and implemented in a single example embodiment. On the contrary, various features described in the context of a single embodiment may be implemented in a plurality of example embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In specific cases, multitasking and parallel processing may be advantageous. In a specific case, multitasking and parallel processing may be advantageous. In addition, it should not be understood that the separation of various device components of the aforementioned example embodiments is required for all the example embodiments, and it should be understood that the aforementioned program components and apparatuses may be integrated into a single software product or packaged into multiple software products.

The example embodiments disclosed in the present specification and the drawings are intended merely to present specific examples in order to aid in understanding of the present disclosure, but are not intended to limit the scope of the present disclosure. It will be apparent to those skilled in the art that various modifications based on the technical spirit of the present disclosure, as well as the disclosed example embodiments, can be made.

What is claimed is:

1. A simulation method comprising:
generating a digital twin object cyberizing a manufacturing resource required for a process based on manufacturing resource information;
mapping a learning model onto the digital twin object and transmitting the learning model mapped onto the digital twin object to a digital twin agent;
receiving information analyzed by using the learning model from the digital twin object of the digital twin agent; and
performing a simulation based on the received information.

2. The simulation method of claim 1, wherein the digital twin agent collects the manufacturing resource information in real time, learns the collected manufacturing resource information using the learning model, and stores information analyzed by learning in the digital twin object.

3. The simulation method of claim 1, wherein the generating of the digital twin object comprises:
generating a simulation model based on the manufacturing resource information collected from the manufacturing resource; and
generating the digital twin object based on the simulation model.

4. The simulation method of claim 1, wherein the digital twin agent learns a process optimized to current manufacturing resource information by applying the manufacturing resource information collected in real time to a process learning model and stores manufacturing resource information required for performing the optimized process in the digital twin object.

5. The simulation method of claim 4, wherein the performing of the simulation comprises performing the simulation by setting a process of a simulation model according to information stored in the digital twin object of the digital twin agent.

6. The simulation method of claim 1, wherein the digital twin agent learns equipment optimized to current manufacturing resource information by applying the manufacturing resource information collected in real-time to an equipment learning model and stores the manufacturing resource information required for setting the optimized equipment in the digital twin object.

7. The simulation method of claim 6, wherein the performing of the simulation comprises performing the simulation by setting equipment of the simulation model based on the information stored in the digital twin object of the digital twin agent.

8. A non-transitory computer-readable storage medium storing instructions that, when executed by a processor, cause the processor to perform the simulation method of claim 1.

9. A simulation system comprising:
a digital twin configurator configured to map a learning model onto a digital twin object cyberizing a manufacturing resource required for a process based on manufacturing resource information and transmit the learning model mapped onto the digital twin object to a digital twin agent; and
a simulator configured to receive information analyzed by using the learning model from the digital twin object of the digital twin agent and perform a simulation based on the received information.

10. The simulation system of claim 9, wherein the digital twin agent collects the manufacturing resource information in real-time, learns the collected manufacturing resource information using the learning model, and stores information analyzed by learning in the digital twin object.

11. The simulation system of claim 9, wherein the digital twin agent learns a process optimized to current manufacturing resource information by applying the manufacturing resource information collected in real-time to a process learning model and stores manufacturing resource information required for performing the optimized process in the digital twin object.

12. The simulation system of claim 11, wherein the simulator performs the simulation by setting a process of a simulation model according to information stored in the digital twin object of the digital twin agent.

13. The simulation system of claim 9, wherein the digital twin agent learns equipment optimized to current manufacturing resource information by applying the manufacturing resource information collected in real-time to an equipment learning model and stores the manufacturing resource information required for setting the optimized equipment in the digital twin object.

14. The simulation system of claim 13, wherein the simulator performs the simulation by setting equipment of the simulation model based on the information stored in the digital twin object of the digital twin agent.
